(19) United States
(12) Patent Application Publication
(10) Pub. No.: US 2004/0261596 A1
(43) Pub. Date: Dec. 30, 2004

(54) Sheet perforation apparatus and image forming apparatus

(75) Inventor: Misao Kobayashi, Kofu-shi (JP)

Correspondence Address: NIXON PEABODY, LLP, 401 9TH STREET, NW, SUITE 900, WASHINGTON, DC, 20004-2128, US

(73) Assignee: NISCA CORPORATION, Minamikoma-gun (JP)

(21) Appl. No.: 10/823,768

(22) Filed: Apr. 14, 2004

(30) Foreign Application Priority Data
Apr. 14, 2003 (JP) 2003-108772

(51) Int. Cl. B26F 1/14

(52) U.S. Cl. 83/691; 234/120; 83/687

(57) ABSTRACT

A sheet perforation apparatus of which number of parts is reduced is provided. Operation pins 251 of punches 250 penetrate pin penetration apertures 221a, 222a and engage guide grooves 210b, 211b formed at sliders 210, 211. The guide grooves 210b, 211b are formed by three groove portions of an upper horizontal groove portion, an inclined groove portion and a lower horizontal groove portion. The sliders 210, 211 are fixed to a slide holder 201 having an engagement pin 202 which engages a cam groove 287a formed at a shaft 287. By rotating a motor 280 normally, the operation pins 251 slide the inclined groove portion so that the punches 250 advance to a perforation position to conduct perforation processing of two holes, and by rotating the motor 280 reversely, the punches 250 conduct perforation processing of three holes. The sliders 210, 211 are common regardless of the number of the punches 250.

### FIELD OF THE INVENTION

The present invention relates to a sheet perforation apparatus and an image forming apparatus, and in particular relates to a sheet perforation apparatus which conducts perforation processing to a sheet discharged from an image forming apparatus such as a copying machine, a printer or the like, and an image forming apparatus which is equipped with the sheet perforation apparatus.

### DESCRIPTON OF RELATED ART

An image formed sheet which is discharged from an image forming apparatus such as a copying machine, a printer, a facsimile machine, or the like is bound by a binder after perforation processing is conducted by a punch or the like (after holes for binding are formed thereto) in general. Recently, a sheet perforation (punching) apparatus for conducting perforation processing to the image formed sheet has come onto the market as a portion of the image forming apparatus, a peripheral apparatus thereof, or a stand-alone type which is independent from the image forming apparatus. In such a sheet perforation apparatus, a plurality of eccentric cams corresponding to a plurality of perforation blades are disposed so as to shift phases thereof, and perforation processing such as two holes, three holes or the like is conducted by selectively moving a different combination of the perforation blades to a position for perforating the sheet according to a shift of the phases, as disclosed, for example, in Japanese Patent Application Laid-Open Number (JPA) 9-136762.

However, since the perforation blades are moved by the eccentric cams in such a conventional sheet perforation apparatus, an excess space is required for pivoting the eccentric cams in a moving direction of the perforation blades. Accordingly, it has brought forth the sheet perforation apparatus large. Further, the same number of eccentric cams as the perforation blades is required for moving the perforation blades to a perforation processing position for the sheet, and springs for retaining the perforation blades at an evacuation position apart from the sheet are also required. Consequently, an increase in the number of parts has caused the sheet perforation apparatus complicated and large.

### SUMMARY OF THE INVENTION

In view of the above circumstances, an object of the present invention is to provide a compact sheet perforation apparatus of which number of parts is reduced.

In order to achieve the above object, a first aspect of the present invention is directed to a sheet perforation apparatus, comprising: a carrying-in section for carrying in a sheet; a plurality of perforation blades for conducting perforation processing to a sheet carried in to the carrying-in section; and a slider, which sets the perforation blades to a selective plural combination, and which has an advance portion for advancing a part of the perforation blades to a perforation position where the perforation processing is conducted to the sheet according to the combination and an evacuation portion for retaining perforation blades other than the part of the perforation blades at an evacuation position that is evacuated from the perforation position, and which supports all of the perforation blades so as the perforation blades to move freely between the evacuation position and the perforation position.

In the first aspect, the slider having an advance portion for advancing perforation blades to a perforation position where the perforation processing is conducted to the sheet and an evacuation portion for retaining perforation blades at an evacuation position that is evacuated from the perforation position supports all of the perforation blades so as to the perforation blades to move freely between the evacuation position and the perforation position. The perforation blades are set to a selective plural combination by the slider. A part of the perforation blades among all of the perforation blades advance (move) to the perforation position to conduct perforation processing to a sheet carried in to the carrying-in section, and perforation blades other than the part of the perforation blades are stopped (retained) at the evacuation position. According to the first aspect, since the slider has a function for advancing the part of the perforation blades to the perforation position in accordance with the combination as well as a function for supporting all of the perforation blades between the perforation position and the evacuation position, the sheet perforation apparatus can be constituted compactly.

In the first aspect, if the advance portion is constituted by a common member which allows the part of the perforation blades to advance to the perforation position at every combination, the sheet perforation apparatus can be constituted more compactly and the number of parts thereof can be reduced, since parts for moving the perforation blades between the perforation and evacuation positions become common and each of the perforation blades needs not to have such parts. In this case, perforation blades next to each other may belong to a different combination. At this time, it is preferable that the slider locates the perforation blades at the perforation position and at the evacuation position by moving to a predetermined position according to the combination. As such an embodiment, each of the perforation blades may have a protruded portion, and a predetermined-shaped guide groove which engages the protruded portion and which supports the perforation blades between the perforation position and the evacuation position is formed at the slider, or, each of the perforation blades may have a portion to be engaged, the slider has an engaging portion which engages the portion to be engaged and which supports the each of the perforation blades between the perforation position or the evacuation position. Further, the sheet perforation apparatus may have a slide holder which supports the slider so as to slide freely and which moves the slider to the predetermined position. When perforation processing is conducted to a bundle of sheets, a stroke in an advancing direction of the perforation blades should be long so that the perforation blades can penetrate a thickness of the bundle of sheets. However, if the slide holder supports the slider in a direction orthogonal to an advancing direction of the perforation blades, the sheet perforation apparatus can be made compactly in the advancing direction of the perforation blades while securing a moving stroke of the perforation blades, since the slider can advance the perforation blades without moving to the advancing direction of the perforation blades. When the sheet perforation apparatus may be equipped with an actuator for moving the slider to the predetermined position, the perforation processing can be conducted by actuating force of the actuator.

Further, in order to achieve the above object, a second aspect of the present invention is directed to a image forming apparatus, comprising: an image forming part for forming an image on a sheet; a conveying part for conveying the sheet on which the image is formed by the image forming part; a plurality of perforation blades for conducting perforation processing to the sheet conveyed by the conveying part; and a slider, which sets the perforation blades to a selective plural combination, and which has an advance portion for advancing a part of the perforation blades to a perforation position where the perforation processing is conducted to the sheet according to the combination and an evacuation portion for retaining perforation blades other than the part of the perforation blades at an evacuation position that is evacuated from the perforation position, and which supports all of the perforation blades so as the perforation blades to move freely between the evacuation position and the perforation position. In the image forming apparatus according to the second aspect, the sheet perforation apparatus according to the first aspect is used as a part of the image forming apparatus or a peripheral apparatus thereof.

### BRIEF DESCRIPTION OF THE DRAWINGS

FIG. 1 is a partially broken-away front view of a copying machine of an embodiment to which the present invention is applicable;

FIG. 2 is an exploded perspective view showing a sheet perforation apparatus of the copying machine of the embodiment;

FIG. 3 is a sectional front view showing the sheet perforation apparatus and a sheet-post processing apparatus of the copying machine of the embodiment; and

FIG. 4 is an explanatory view illustratively showing a position relationship between a guide groove formed at a slider and punches of the sheet perforation apparatus of the copying machine of the embodiment.

### DETAILED DESCRIPTION OF THE PREFERRED EMBODIMENTS

Embodiments of a copying machine serving as an image forming apparatus to which the present invention is applied will be explained below with reference to the drawings.

(Constitution)

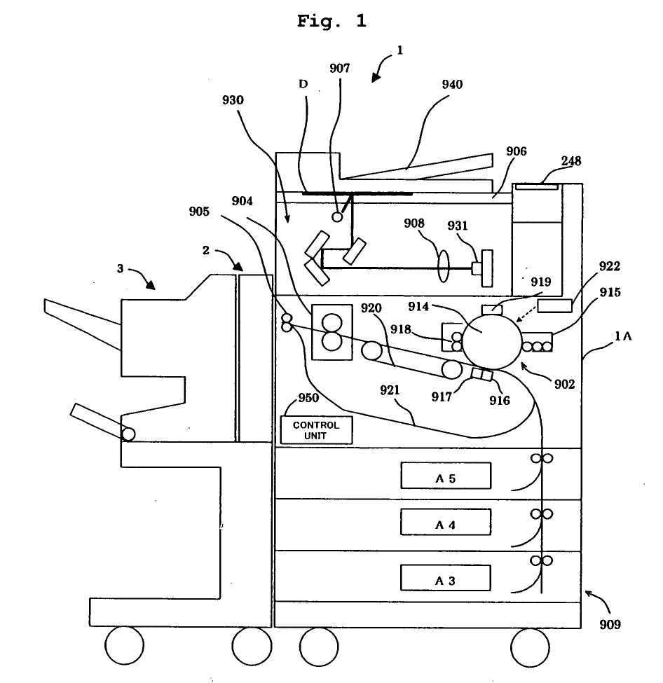

As shown in FIG. 1, a copying machine 1 of the present embodiment is equipped with a digital copying machine main body 1A which forms an image on a sheet, a sheet perforation apparatus 2 which is mounted to a side portion of the copying machine main body 1A and which conducts perforation processing to a sheet conveyed from the copying machine main body 1A, and a sheet post-processing apparatus 3 which is mounted to a downstream side face of the sheet perforation apparatus 2 and which carries out binding processing and/or folding processing to a bundle of sheets.

<1. Copying Machine Main Body>

The copying machine main body 1A is constituted with an image forming section 902 which forms a copy image of an original document D on a sheet, an image inputting section 930 which is disposed at an upper side of the image forming section 902 and which has a light source 907 and functions as a so-called scanner so as to form an image of reflected light from the original document D via an optical system 908 onto a CCD 931, and a control unit 950 which controls operation of these sections.

The image forming section 902 has a cylindrical photoconductor drum 914 which is capable of forming a latent image to an outer peripheral surface thereof. A first charging unit 919 for charging static electricity to form a latent image on the photoconductor drum 914, a laser unit 922 for outputting a modulated laser beam to the photoconductor drum 914 depending upon image data memorized in a hard disk, a developing unit 915 which develops the latent image formed on the photoconductor drum 914 into a toner image, a transfer-charging unit 916 for charging electricity to transfer the toner image onto a sheet, a separation-charging unit 917 for separating a sheet from the photoconductor drum 914 by giving charge antipolar to the transfer-charging unit 916, and a cleaner 918 for cleaning the photoconductor drum 914 are respectively disposed around the photoconductor drum 914.

The laser unit 922 is constituted with a semiconductor laser which generates a laser beam, a polygon mirror which transforms the laser beam outputted from the semiconductor laser via a collimator lens into a line beam, a f-theta lens which transforms a laser beam of every scanning line from the polygon mirror into parallel light, a mirror for reflecting and guiding the parallel light from the f-theta lens to the photoconductor drum 914, and a motor for rotating the polygon mirror.

A roller to which an endless conveying belt 920 is suspended is disposed at a downstream side of the photoconductor drum 914 and at a vicinity of the separation-charging unit 917. The endless conveying belt 920 is bridged or entrained over to a roller which is disposed at a vicinity of a fixing unit 904 that has a heat roller and that heats and fixes the toner image formed on a sheet. A discharging roller pair 905 serving as a conveying part for discharging a sheet on which an image is formed from the copying machine main body 1A is disposed at a downstream side of the fixing unit 904. A duplex 921 for carrying out double face printing to form an image on another face of the sheet that an image has been fixed on one face.

A platen glass 906 for placing the original document D is disposed at an upper portion of the copying machine main body 1A, and an auto document feeder (hereinafter abbreviated as an ADF) 940 whose one side is fixed to an end portion of the copying machine main body 1A and whose another side is allowed to rotate so as to cover the platen glass 906 and which feeds the original document D to the platen glass 906 automatically is disposed at an upper side of the platen glass 906. Further, a sheet feeding apparatus 909 which feeds a sheet having a predetermined size to the copying machine main body 1A one by one is attached at a lower side of the copying machine main body 1A. The sheet feeding section 909 has attachable/detachable cassettes, each of which accommodates A5, A4, and A3 size sheets. The sheet feeding apparatus 909 is controlled by an unillustrated controller which controls rotation operation of a pair of rollers for feeding a sheet toward the image forming section 902. Incidentally, an operation can set selection of a sheet size or the like via a touch panel 248.

The control unit 950 is constituted with a CPU (hereinafter referred to as a CPU 1A) operating as a central processing unit, a ROM in which a fundamental control program of the image copying machine 1A has been memorized, and a RAM which works as a working area for the CPU 1A, and an internal bus for connecting these elements. The control unit 950 is connected to an external bus. The external bus is connected to the image inputting section 930, an A/D converting section which converts analog image data inputted by the image inputting section 930 to digital image data, the image forming section 902, a touch panel control unit 250 for controlling indication to the touch panel 248 and inputted operation commands from the touch panel 248, and the hard disk for memorizing image data transmitted from the image inputting section 930 or an external apparatus such as a personal computer and the like.

<2. Sheet Perforation Apparatus>

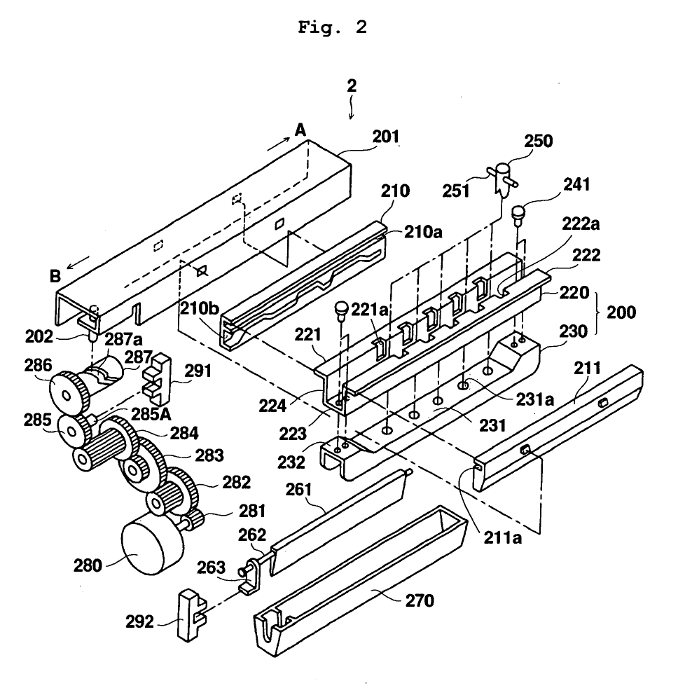

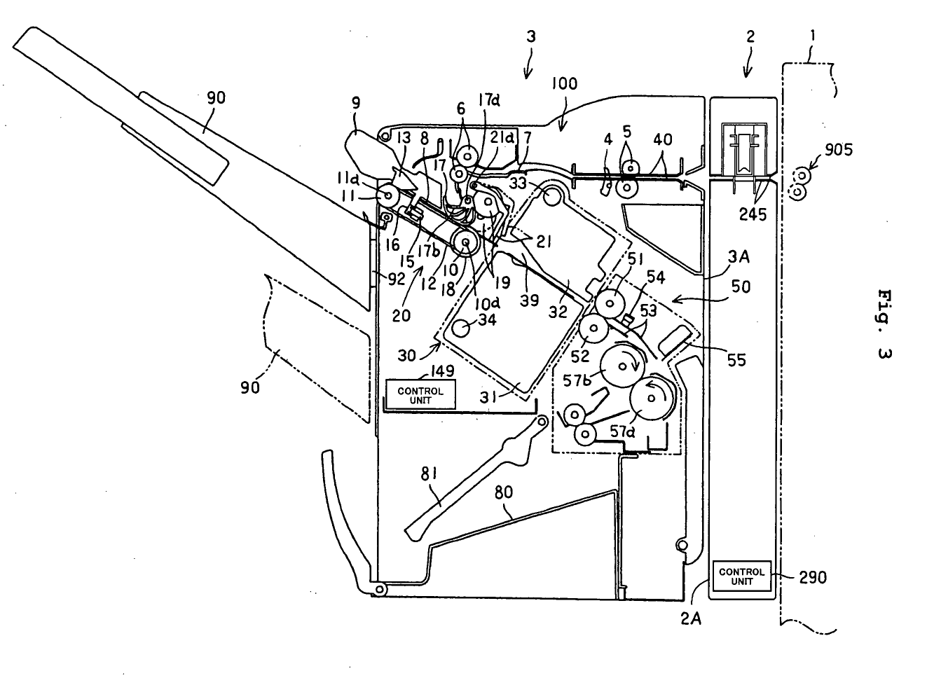

As shown in FIG. 2, the sheet perforation apparatus 2 has five cylindrical punches 250 which conduct a sheet perforation processing and which serve as perforation blades. A perforation blade is formed at a lower side of each of the punches 250, and the punches 250 have operation pins 251 which penetrate the punches 250 in an orthogonal direction of each axis of the punches 250 and which serve as an protruded portion. The punches 250 are accommodated in a punch guide 200 which is fixed to a conveying guide 245 (See FIG. 3.) which serves as a part of a carrying-in section. The punch guide 200 is constituted by an upper punch guide 220 and a lower punch guide 230.

The upper punch guide 220 is made of a channel-shaped member, and has flange portions 221, 222 which are bended toward an external direction like a cross sectional shape of approximately letter L at both build-up portions 224 of the channel-shaped member. Further, five pin penetration apertures 221a which are notched like a rectangular shape are formed at one side of the build-up portions 224 and the flange portion 221 so as to communicate therebetween, and pin penetration apertures 222a are formed at positions opposed to the pin penetration apertures 221a at another side of the build-up portions 224 and the flange portion 222 in the same manner as the pin penetration apertures 221a. Furthermore, five circular penetration holes (not shown) which allow the perforation blades of the punches 250 to advance downward and which correspond to positions of the pin penetration apertures 221a, 222a formed at the build-up portions, are formed at a center of a bottom channel portion 223 of the upper punch guide 220.

On the other hand, the lower punch guide 230 is also made of a channel-shaped member, and has a central flat portion 231 and protruded flat portions 232 which protrude upwards from both sides of the central flat portion 231. Further, five circular penetration holes 231a which allow the perforation blades of the punches 250 to advance downward and which correspond to positions of the circular penetration holes formed at the bottom channel portion 223 of the upper punch guide 220, are formed at the central flat portion 231.

The bottom channel portion 223 of the upper punch guide 220 and the protruded flat portion 232 of the lower punch guide 230 are fastened by screws 241 at their both ends. Further, a space (hereinafter referred as to a carrying-in space) which allows a sheet to carry in or convey and which serves as a part of a carrying-in section, is formed between the bottom channel portion 223 of the upper punch guide 220 and the central flat portion 231 of the lower punch guide 230.

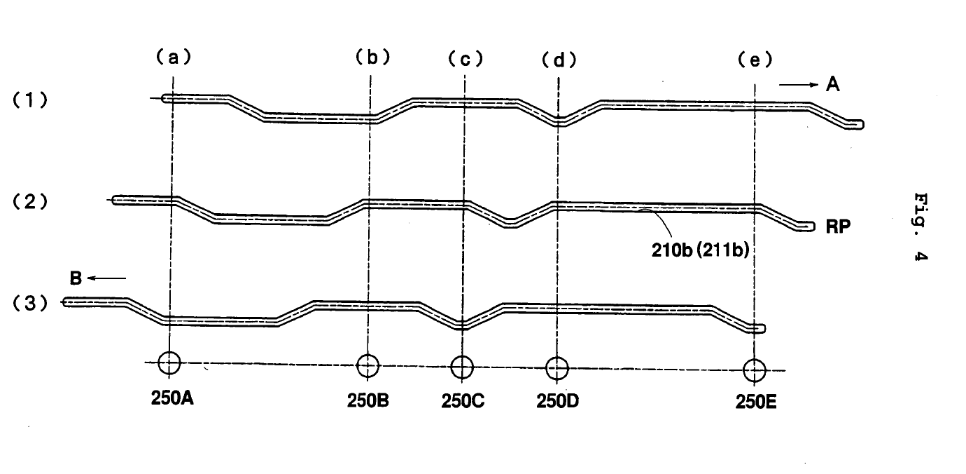

The operation pins 251 of the punches 250 penetrate the pin penetration apertures 221a, 222a and engage guide grooves 210b, 211b (See FIG. 4.) formed at sliders 210, 211. The guide grooves 210b, 211b are formed in a lengthwise direction at surfaces, opposing to the upper punch guide 220, of the sliders 210, 211 respectively so as to communicate three groove portions of an upper horizontal groove portion, a lower horizontal groove portion, and an inclined groove portion which connects the upper horizontal groove portion and the lower horizontal groove portion. Approximately horizontal slider grooves 210a, 211a are formed at upper portions of the guide grooves 210b, 211b in a lengthwise direction of the sliders 210, 211. Tips of flange portions 221, 222 of the upper punch guide 220 respectively engage the slider grooves 210a, 211a.

The sliders 210, 211 have two projecting portions respectively at surfaces opposing to the surfaces at which the slider grooves 210a, 211a and the guide grooves 210b, 211b are formed. The projecting portions fit rectangular windows formed at build-down portions of an approximately channel-shaped slide holder 201 so that the sliders 210, 211 are fixed to the channel-shaped slide holder 201. An engagement pin 202 is anchored to one side of the slide holder 201. A lower portion of the engagement pin 202 engages a cam groove 287a formed at a shaft 287. A gear 286 is fixed to one end of the shaft 287 and another end of the shaft 287 is supported pivotably by an unillustrated supporting member.

Rotation driving force is conveyed from a stepping motor 280 which reversibly rotates to the gear 286 via a gear 281 which is fixed to a motor shaft of the motor 280, a gear 282 geared with the gear 281, and gears 283, 284, 285. Thus, according to normal/reverse rotation of the shaft 287, the slide holder 201 slides in a direction of an arrow A or an arrow B in FIG. 2 due to the engagement pin 202 engaged with the cam groove 287a. The slide holder 201 supports the sliders 210, 211 in a direction orthogonal to the advancing direction of the punches 250. The motor 280, the engagement pin 202, the gear 286, the shaft 287, the cam groove 287a and the like function as a part of an actuator. It should be noted that a RP detecting piece 285A for detecting a reference position of the cam groove 287a, namely, a reference position (hereinafter abbreviated as a RP) of the guide grooves 210b, 211b formed at the sliders 210, 211, is protruded from the gear which is geared with the gear 286. The RP of the RP detecting piece 285A or the RP of the guide grooves 210b, 211b is detected by a detecting sensor 291.

A pedestal (not shown) for receiving punch chips is disposed at a downward portion of the lower punch guide 230. A flapper 261 for sweeping the punch chips away from the pedestal by pivoting around a pivoting shaft 262 according to rotation force from an unillustrated motor so as to drop the punch chips down to a chips storing box 270, is disposed at one side of the pedestal. A detecting piece 263 for detecting a reference position of the flapper 261 is fixed to the pivoting shaft 262. The detecting piece 263, namely, a reference position of the flapper 261 is detected by a detecting sensor 292.

As shown in FIG. 3, the above constituting members are housed in an apparatus frame 2A which is a casing of the sheet perforation apparatus 2. Further, the sheet perforation apparatus 2 has a control unit 290 which controls all of the sheet perforation apparatus 2. The control unit 290 is constituted to include a CPU (hereinafter referred to as a CPU 2), a ROM that memorizes in advance programs to be carried out by the CPU 2 and program data, a RAM that functions as a working area for the CPU 2 and memorizes setting data and the like received from the control unit 950 of the copying machine main body 1A, an interface, and the like. Incidentally, the flapper 261, the chips storing box 270, the motor 280 and the like which are shown in FIG. 2 are omitted in FIG. 3

<3. Sheet Post-Processing Apparatus>

As shown in FIG. 3, in an apparatus frame 3A which is a casing, the sheet post-processing apparatus 3 has a conveying unit 100 which conveys a sheet discharged from the copying machine main body 1A to an opposite side of the discharging roller pair 905 in a generally horizontal direction, an arranging unit 20 which is disposed slantingly at a downstream side of the conveying unit 100 and which is capable of arranging end portions of sheets, a stapler unit 30 which is disposed slantingly at a downstream side of the arranging unit 30 and which carries out binding processing to a bundle of sheets, a folding unit 50 which is disposed slantingly at a downstream side of the stapler unit 30 and which carries out folding processing to the bundle of sheets such that a predetermined position of the bundle of sheets as a folding position is folded, a stacking unit for stacking the bundle of sheets or a booklet (a bundle of sheets that folding processing is carries out), and a control unit 149 which controls each unit of the sheet post-processing apparatus 3.

The conveying unit 100 has a conveying guide 40 which guides a sheet into an interior of the sheet post-processing apparatus 3, a carry-in guide 7 which further guides the sheet downstream, a conveying roller pair 5 which is disposed at the conveying guide 40 and which nips and conveys the sheet, a sheet detecting sensor 4 which detects an end of the sheet carried in the carry-in guide 40, and a discharging roller pair 6 which is disposed at an end downstream side of the carry-in guide 7 and which nips and discharges the sheet.

The arranging unit 20 has a processing tray 8 for stacking the sheet discharged from the discharging roller pair 6. The processing tray 8 is disposed slantingly at about 30 degrees to a platen glass 906 of the copying machine main body 1A with a sheet conveying direction downward in order to urge the sheet to convey downstream. Arranging plates 9 which move and arrange the sheet so as to guide both ends of the sheet to a center side are disposed on the processing tray 8. An unillustrated arranging motor is disposed at a lower position of the processing tray 8. A pinion 15 is fixed to a motor shaft of the arranging motor. Slender and rectangular shaped fixing members are extended from a lower side of the arranging plates 9. A tip portion of each fixing member penetrates a slot formed in a width direction of the processing tray 8 so as to be fixed to the rack 16. Accordingly, the arranging plates 9 are capable of moving toward the width direction of the processing tray 8 by rotation drive of the arranging motor according to a size of the sheet.

Pulleys 10, 11 are respectively fixed to pulley axes 10a, 11a at a central and lower position of the processing tray 8. An endless conveying belt 12 is entrained between pulleys 10, 11. A lower conveying roller 18 is fixed to the pulley axis 10a. A portion of an outer circumference of the lower conveying roller 18 is exposed from an upper surface of the processing tray 8 via a notched portion formed at the processing tray 8. Driving force is conveyed from an unillustrated reversibly rotatable stepping motor to the pulley axis 10a.

On the other hand, an upper conveying roller 19, which is capable of moving between an abutting position where the upper conveying roller 19 abuts against the lower conveying roller 18 as shown by a two-dot chain line and an alienating position where the upper conveying roller 19 alienates from the lower conveying roller 18 as shown by a full line, is disposed upward the upper conveying roller 18. The moving of the upper conveying roller 19 between the abutting position and the alienating position is carried out by operation of an unillustrated cam and the like, and rotation force of the upper conveying roller 19 is imparted from the above unillustrated stepping motor via gears.

A paddle 17 which rotates on an axis 17a by rotation force supplied from an unillustrated paddle motor and urges the sheet to a sheet conveying direction is disposed downward the carry-in guide 7 and upward the processing tray 8. The paddle 17 is made of an elastic member such as a rubber member and the like with a predetermined elasticity and which has a fin 17b formed integrally and radially from the axis 17a as its center. The paddle 17 is easy to deform when the sheet is discharged and stacked on the processing tray 8 and is capable of imparting appropriate urging force to the sheet being conveyed in the sheet conveying direction.

A thrusting pawl 13, which thrusts the bundle of sheets out toward a side of the ascending/descending tray 90 so as its end surface to abut on one end portion of the bundle of sheets which is piled on the processing tray 8, is fixed to the endless conveying belt 12. A home position (hereinafter, abbreviated as HP) is set for the thrusting pawl 13. The HP is set at a position where the end surface of the thrusting pawl 13 positions just under the pulley axis 10a. A detecting arm that engages with the trusting pawl 13 and an arm detecting sensor consisting of a transmission type integrated sensor are disposed at a lower side of the endless conveying belt 12 in order to detect the HP of the thrusting pawl 13.

A stopper 21 for regulating and arranging one end of the sheet which is urged so as to drop on the slantingly disposed processing tray 8 in the sheet conveying direction by its own weight and which is further urged by rotation of the paddle 17 is disposed at an upper side of the processing tray 8 and at a side of the stapler unit 30. The stopper 21 has a cross sectional shape of approximately letter J and has a leg portion and an arm portion. One side of the arm portion of the stopper 21 is connected to a plunger of an unillustrated solenoid, and another side of the arm portion is pulled by a spring with predetermined tensile force. The stopper 21 is capable of pivoting around a supporting axis as a fulcrum positioning at approximately a center of the arm position and is capable of moving between a regulating position where a bottom face of the leg portion (tip of the leg portion) abuts against the upper face of the processing tray 8 as shown by a full line and an evacuated position where the bottom face of the leg portion is evacuated from the upper face of the processing tray 8 as shown by a two-dot chain line according to an on/off state of the unillustrated solenoid.

The thrusting pawl 13 is capable of moving toward a side of ascending/descending tray 90 at a normal time (i.e., The upper conveying roller 19 is disposed at the alienating position and the stopper 21 is disposed at the evacuated position). Therefore, the thrusting pawl 13 is capable of conveying the bundle of sheets whose one end portion is arranged by the stopper 21 which is disposed at the regulating position, or of conveying the bundle of sheets whose one end portion is arranged to the side of the staple unit 30 with nipping by both the lower conveying roller 18 and the upper conveying roller 19 which positions at the abutting position.

The stapler unit 30 is disposed at a downstream side of the arranging unit 20, and has a head assembly 31 which is disposed at an upper side and which has a cartridge for staple needles and punches a staple needle out and an anvil assembly 32 which is disposed at a lower side and which receives and bends the tip portions of the staple needle punched out from the head assembly 31 so as the assemblies 31, 32 to nip a conveying path 39 for conveying the bundle of sheets. The stapler unit 30 has a function for carrying out binding processing to an end portion or a center portion of the bundle of sheets according to a conveying distance of the bundle of sheets which is nipped and conveyed by the lower conveying roller 18 and the upper conveying roller 19. The stapler unit 30 is capable of carrying out the binding processing with the staple needles to a plurality of portions of the bundle of sheets via cylindrical guiding rods 33, 34 for supporting and guiding the head assembly 31 and the anvil assembly 32 in a direction intersecting to the sheet conveying direction. Incidentally, the stapler unit 30 is constituted as a unit as shown by a two-dot chain line and is configured to allow drawing out from the sheet post-processing apparatus 3 such that the staple needles can be supplied.

The folding unit 50 is constituted as a unit as shown by a two-dot chain line and is disposed at a downstream side of the stapler unit 30. The folding unit 50 is configured to allow drawing out from the sheet post-processing apparatus 3 in the same manner as the stapler unit 30.

An upper bundle-conveying roller 51 and a lower bundle-conveying roller 52 for nipping and conveying the bundle of sheets downstream are disposed at an entrance of the folding unit 50. A bundle conveying guide 53 for guiding to a further downstream side the bundle of sheets which is conveyed by the upper bundle-conveying roller 51 and the lower bundle-conveying roller 52 is disposed at a downstream side of the roller pair. An end detecting sensor 54 which is a transmission type integrated sensor and which detects a leading end of the bundle of sheets is disposed at a bundle conveying path formed by the bundle conveying guide 53. The control unit 149 controls to drive the upper bundle-conveying roller 51 to contact with the lower bundle-conveying roller 52 according to a leading end detecting signal from the end detecting sensor 54 and controls setting of a folding position in a conveying direction of the bundle of sheets.

The upper bundle-conveying roller 51 is constituted so as to be movable between a position where it contacts with the lower bundle-conveying roller 52 with pressure and a position where it alienates from the lower bundle-conveying roller 52 (not shown). The upper bundle-conveying roller 51 and the lower bundle-conveying roller 52 take an alienating state until the leading end of the bundle of sheets is detected by the end detecting sensor 54, and when the leading end of the bundle of sheets is detected, they take a contacting state. The upper conveying roller 19 shifts from the abutting position to the alienating position almost synchronizing with the contacting state. Accordingly, the conveying of the bundle of sheets downstream is handed over to the conveying with pressure by the upper bundle-conveying roller 51 and the lower bundle-conveying roller 52.

A roller pair consisting of folding rollers 57a, 57b which are urged with each other so as to contact with pressure in a direction intersecting to the conveying direction of the bundle of sheets and which are driven to rotate respectively is disposed at a lower side of the conveying guide 53 in order to fold the bundle of sheets. A pushing plate 55 whose head edge advances to a vicinity of a contacting position of the folding rollers 57a, 57b so as to push the bundle of sheets to the contacting position of the folding rollers 57a, 57b is disposed at a downstream side of the conveying guide 53 and in a direction intersecting to the conveying direction of the bundle of sheets.

The folding unit 50 conducts folding processing to the bundle of sheets at a position of ½ (center) from a leading end portion in a conveying direction when a sheet is conveyed in a longitudinal direction. A folded bundle discharging stacker 80, which has an inclined face opposing to inclined dispositions of the arranging unit 20, the stapler unit 30 and the folding unit 50 and which stacks the bundle of sheets that the folding processing has been carried out by the folding unit 50, is disposed at a downstream side of the folding unit 50 and at a bottom position of the sheet post-processing apparatus 3. A folded bundle holding foot 81 of which one end is rotatably fixed and which holds the discharged bundle of sheets with urged force of a spring or the like coupled with dropping force of the inclined face of the folded bundle discharging stacker 80, is disposed at an upper side of the folded bundle discharging stacker 80.

Further, the ascending/descending tray 90 which is capable of ascending and descending in a vertical direction to the apparatus frame 2A is disposed at a side face of the apparatus frame 2A which is a side opposing to the sheet perforation apparatus 2. The ascending/descending tray 90 is supported by an ascending/descending support member 92.

The control unit 149 is constituted to include a CPU (hereinafter referred to as a CPU 3), a ROM that memorizes in advance programs to be carried out by the CPU 3 and program data, a RAM that functions as a working area for the CPU 3 and memorizes setting data and the like received from the control unit 950 of the copying machine main body 1A, an interface, and the like.

(Operation)

Next, operation of the copying machine 1 according to the present embodiment will be explained. After the original document(s) D is/are set at the ADF 940 and a change in setting contents or inputting of undecided contents indicated by the touch panel 248 is carried out according to finger touch by an operator, when a start button of the touch panel 248 is touched, the CPU 1A fetches all of setting information which are sent from the touch panel control unit 250. An example in a case that a mode for conducting perforation processing of two holes or three holes to a sheet is set will be explained below.

The CPU 1A fetches image data read by the image inputting section 930 via the A/D converter and stores the data into the hard disk one after another. Then, after transmitting setting information relating to the sheet perforation apparatus 2 and the sheet post-processing apparatus 3 respectively to the control units 290, 149, the CPU 1A controls the image forming section 902 to form an image on a sheet in accordance with image data stored in the hard disk.

That is, the CPU 1A outputs to the sheet feeding apparatus 909 a sheet-feeding signal for bringing the sheet feeding apparatus 909 to feed a sheet having a predetermined size. The control unit of the sheet feeding apparatus 909 drives a roller pair to rotate so as to feed a sheet having the predetermined size from the designated cassette. The skew of the sheet is revised by the roller pair in the sheet feeding section 909, and the sheet is conveyed to the image forming section 902 after the timing of feeding the sheet is adjusted. The CPU 1A controls the laser unit 922 to irradiate image data for one sheet line by line to the photoconductor drum 914. The photoconductor drum 914 is charged in advance by the first charging unit 919, and a static latent image is formed on the photoconductor drum 914 by irradiated light. The developing unit 915 develops the static latent image so that a toner image is formed on the photoconductor drum 914.

The toner image on the photoconductor drum 914 is transferred onto the fed sheet by the transfer-charging unit 916 in the image forming section 902. The sheet on which the toner image is transferred is separated from the photoconductor drum 914 by the separation-charging unit 917 with charge antipolar to the transfer-charging unit 916. Further, the separated sheet is conveyed to the fixing unit 904 by the endless conveying belt 920. The transferred image is fixed permanently by the fixing unit 904 so that an image is formed (recorded) on the sheet. When double face printing is carried out, an image is formed on another face of the sheet via the duplex 921.

Thereafter the sheet on which an image is formed is discharged from the copying machine main body 1A to the sheet perforation apparatus 2 one by one by the discharging roller pair 905. An unillustrated sensor is disposed at a downstream side of the discharging roller pair 905. The CPU 1A stops the sheet conveying when the discharging roller pair 905 rotates a predetermined steps after the unillustrated sensor detects a leading end of the sheet. Thus, a portion where perforation is to be processed stops at the above stated conveying-in space via the conveying guide 245 inside the sheet perforation apparatus 2. Further, the CPU 1A notifies the CPU 2 of the stopping of the sheet conveying.

The CPU 2 which is notified from the CPU 1A rotates the motor 280 in accordance with setting of two or three holes which is also notified from the CPU 1A. The CPU 2 rotates the motor 280 normally (CW) to move the slide holder 201 to the direction of the arrow A in FIG. 2 in a case that the setting is two holes, and rotates the motor 280 reversely (CCW) to move the slide holder 201 to the direction of the arrow B in FIG. 2 in a case that the setting is three holes. Incidentally, the CPU 2 determines as to whether or not the detecting sensor 291 detects the RP detecting piece 285A at initial setting processing which is carried out after power-on, and when a negative determination is made, the slide holder 201 is positioned at a reference position at the initial setting processing by operating the motor 280 until the detecting sensor 291 detects the RP detecting piece 285.

Here, a relationship between the punches 250 and the guide grooves 210b, 211b will be explained in detail with reference to FIG. 4. As stated above, the sliders 210, 211 are fixed to the slide guide 210. Accordingly, when the slide guide 201 positions at the reference position, the guide grooves 210b, 211b also position at the RP. (2) in FIG. 4 illustratively shows the guide groove 210b (211b) in this state.

Now, when the five punches 250 are denoted as 250A, 250B, 250C, 250D, 250E, and their operations pins 251 are denoted as 251A, 251B, 251C, 251D, 251D respectively in the order nearer to the motor 280 shown in FIG. 2, the punch 250A positions at a position of (2)(a) in FIG. 4, the punch 250B at (2)(b), the punch 250C at (2)(c), the punch 250D at (2)(d) and the punch 250E at (2)(e) at the RP. In other words, the operation pin 250A engages at a position of (2)(a) the guide groove 210b (211b) which positions at the RP, the operation pin 250B at a position of (2)(b), the operation pin 250C at a position of (2)(c), the operation pin 250D at a position of (2)(d), the operation pin 250E at a position of (2)(e). Here, it should be noted that engaging positions of the operation pins 251A-251E positioning at the RP with the guide groove 210b (211b) are located all at the above stated upper horizontal groove portion. Therefore, the perforation blades of the punches 250A-250E are located at an evacuation position where the perforation blades are positioned upper than the bottom channel portion 223 of the upper punch guide 220 (a state shown in FIG. 3), so that a sheet can be directly conveyed to a side of the sheet post-processing apparatus 3 even in a case that the perforation processing is not set. Incidentally, in such a case, the CPU 1A does not carry out the above stated stopping of the sheet conveying but it controls the sheet to convey to the sheet post-processing apparatus 3 via the sheet perforation apparatus 2.

When the motor 280 is rotated normally a predetermined number of steps so as to move the slide holder 201 to the direction of the arrow A in FIG. 2, the slider 210 (211) slides a predetermined distance from the RP to the direction of the arrow A as shown in (1) of FIG. 4 since the slider 210 (211) is fixed to the slide holder 201. When the guide groove 210b (211b) slides, the operation pins 251A-251E have small allowance but they can not move to the direction of the arrow A because they are regulated by the pin penetration apertures 221a (222a). Accordingly, the operation pin 251A slides at the upper horizontal groove portion to position at (1)(a), the operation pin 251B slides from the upper horizontal groove portion to the lower horizontal groove portion (1)(b) via the inclined groove portion, the operation pin 251C slides at the upper horizontal groove portion to position at (1)(c), the operation pin 251D slides from the upper horizontal groove portion to the lower horizontal groove portion (1)(d) via the inclined groove portion, and the operation pin 251E slides at the upper horizontal groove portion to position at (1)(e), respectively. In short, the operation pins 251B, 251D are guided inside the inclined groove portion gradually to a perforation position of the lower horizontal groove position, and the perforation blades of the punches 250B, 250D penetrate the circular penetration holes formed at the bottom channel portion 223 and the circular penetration holes formed at the central flat portion 231. As a result of this, the perforation processing of the two holes is conducted to the sheet. Incidentally, the punches 250A, 250C and 250E are retained at the evacuation position since the operation pins 251A, 251C and 251E slide inside the upper horizontal groove portion.

On the other hand, when the motor 280 is rotated reversely a predetermined number of steps so as to move the slide holder 201 to the direction of the arrow B in FIG. 2, the slider 210 (211) slides a predetermined distance from the RP to the direction of the arrow B as shown in (3) of FIG. 4. When the guide groove 210b (211b) slides, the operation pins 251A-251E can not move to the direction of the arrow B because they are regulated by the pin penetration apertures 221a (222a) as stated above. Accordingly, the operation pin 251A slides from the upper horizontal groove portion to the lower horizontal groove portion (3)(a) via the inclined groove portion, the operation pin 251B slides at the upper horizontal groove portion to position at (3)(b), the operation pin 251C slides from the upper horizontal groove portion to the lower horizontal groove portion (3)(c) via the inclined groove portion, the operation pin 251D slides at the upper horizontal groove portion to position at (3)(d), and the operation pin 251E slides from the upper horizontal groove portion to the lower horizontal groove portion (3)(e) via the inclined groove portion, respectively. In short, the operation pins 251A, 251C and 251E are guided inside the inclined groove portion gradually to the perforation position of the lower horizontal groove position, and the perforation blades of the punches 250A, 250C and 250E penetrate the circular penetration holes formed at the bottom channel portion 223 and the circular penetration holes formed at the central flat portion 231. As a result of this, the perforation processing of the three holes is conducted to the sheet. Incidentally, the punches 250B and 250D are retained at the evacuation position since the operation pins 251B and 251D slide inside the upper horizontal groove portion.

Accordingly, in the present embodiment, among the punches 250A-250E, punches (perforation blades) next to each other belong to a different combination for perforation processing. Further, in order to realize the selective plural combination of the punches 250 to conduct the perforation processing of the two or three holes, the guide groove 210b (211b) is formed at the slider 210 (211) by connecting the three groove portions of the upper horizontal groove portion, the lower horizontal groove portion and the inclined groove portion. Among the three groove portions, the upper horizontal groove portion functions as an evacuation portion for stopping (retaining) the punches 250 at the evacuation position, the inclined groove portion functions as an advance portion for advancing the punches 250 to the perforation position. More in detail, the inclined groove portion has a function for giving pressing force to the punches 250 downward by the engagement with the operation pins 251, and the lower horizontal groove portion functions as moderation to the punches 250 which have advanced down to the lowermost end of the perforation position. Further, the five punches 250 is supported by the slider 210 (211) so as to move freely between the evacuation position and the perforation position by adopting a structure that the operation pins 251 engages the guide groove 210b (211b).

After conducting the perforation processing of two or three holes to the sheet by rotating the motor 280 normally or reversely, the CPU 2 drives the motor 280 a predetermined number of steps reversely or normally and determines as to whether or not the detecting sensor 291 detects the RP detecting piece 285A. If the determination is affirmative, the CPU 2 stops the motor 280. If the determination is negative, the CPU 2 drives the motor 280 reversely or normally until the detecting sensor 291 detects the RP detecting piece 285A to stop the motor 280. Then, the CPU 2 notifies the CPU 1A of the stopping of the motor 280. In short, the guide groove 210b (211b) of the slider 210 (211) positions at the RP by driving the motor 280 the predetermined number of steps reversely or normally, and the punches 250 which have advanced to the perforation position is located at the evacuation position. Thus, the sheet can pass through the carrying-in space without being blocked by the punches 250 which has advanced to the carrying-in space.

The CPU 1A which is notified from the CPU 2 rotates the stopped-state discharging roller pair 905, and stops the rotation of the discharging roller pair 905 when an unillustrated sensor disposed at a downstream side of the discharging roller pair 905 detects a rear end of the sheet. Thus, the sheet is conveyed to the sheet post-processing apparatus 3.

When receiving the setting information relating to the sheet post-processing apparatus 3 from the CPU 1A, CPU 3 moves the head assembly 31 and the anvil assembly 32 to their initial positions, and waits until the sheet is conveyed from the copying machine main body 1A via the sheet perforation apparatus 2. Operation of the sheet post-processing apparatus 3 will be explained below in accordance with setting modes.

<(1) Non-Binding Processing Mode>

When receiving from the setting information of a non-binding (non-staple) processing mode, the CPU 3 drives an unillustrated stepping motor first to move the thrusting pawl 13 from the HP to a pre-home position (PreHP) which is a sheet accumulation reference on the processing tray 8 and where the end face of the thrusting pawl 13 gets close to the ascending/descending tray 90 a predetermined distance from right above the pulley axis 10a. At this time, the upper conveying roller 19 is located at the alienating position and the stopper 12 is located at the evacuated position. Incidentally, the moving from the HP to the PreHP may be carried out by counting the number of pulses which are transmitted to the unillustrated stepping motor.

At the same time, the CPU 3 rotates a live roller of the discharging roller pair 6 and waits until the sheet is conveyed from the copying machine main body 1A. When the sheet is discharged from the copying machine main body 1A, the sheet is conveyed to the processing tray 8 by the conveying roller pair 5 and the conveying roller pair 6. When the sheet is detected by the sheet detecting sensor 4, the CPU 3 counts the timing for driving the arranging motor which moves the arranging plates 9 and for driving the puddle motor which rotates the puddle 17.

When the sheet is discharged on the processing tray 8, the CPU 3 drives the arranging motor and the puddle motor. Due to the driving, the arranging plates 9 move in a width direction which is orthogonal to the sheet conveying direction to arrange both ends of the sheet, and the puddle 17 rotates so as to align (arrange) the end of the sheet to the end surface of the thrusting pawl 13 which positions at the PreHP in advance. This operation is repeated every time the sheet is discharged on the processing tray 8.

When the predetermined number of sheets is arranged at the end surface of the thrusting pawl 13, the CPU 3 stops driving of the arranging motor and the puddle motor, and drives the unillustrated stepping motor which operates the endless conveying belt 12 to forward the bundle of sheets to the side of the ascending/descending tray 90 by trusting the bundle with the end surface of the thrusting pawl 13. Thus, the bundle is placed on the ascending/descending tray 90. When the bundle is placed on the ascending/descending tray 90, the CPU 3 rotates an unillustrated ascending/descending tray motor to descend the ascending/descending tray 90 a predetermined distance, and then rotates the unillustrated ascending/descending tray motor reversely to ascend the ascending/descending tray 90. The ascending/descending tray 90 is retained at this position until the next bundle is placed.

Accordingly, in the non-binding processing mode in which no binding processing is necessary, since the thrusting pawl 13 is positioned at the PreHP in advance, the bundle of the sheets is stacked, and the bundle is trusted to the side of the ascending/descending tray 90 without conveying the sheet(s) to the regulating position of the stopper 21, even if a sheet discharging speed of the copying machine main body 1A is high like in a case that the perforation processing is not conducted to the sheet(s), the sheet post-processing apparatus 3 can keep up with the sheet discharging speed.

When receiving the setting information of an end biding processing mode from the CPU 1A, the CPU 3 positions the stopper 21 at the regulating position by turning on an unillustrated solenoid, rotates the live rollers of the conveying roller pair 5 and the conveying roller pair 6 to discharge the sheet(s) discharged from the copying machine main body 1A on the processing tray 8, and then drives the arranging motor and the puddle motor. The both ends in a width direction of the sheet is arranged by the arranging plates 9, then, the sheet is urged to move on the upper face of the processing tray 8 until it reaches a position where the leading end of the sheet abuts on a side face of the leg portion of the stopper 21 so as to stop at an appropriate position. By repeating this manner a predetermined number of sheets, a bundle of sheets is laid in a state that the stopper 21 regulates an edge portion of the bundle of sheets.

Next, after moving the upper conveying roller 19 to the side of the lower conveying roller 18 so as to nip the bundle of sheets therebetween in the state that the stopper 21 regulates the bundle of sheets, the CPU 3 turns off the unillustrated solenoid so as to position the stopper 21 at the evacuated position. Then, the CPU 3 actuates the unillustrated stepping motor by a predetermined number of steps reverse to the non-binding processing mode. According to this actuation, the upper conveying roller 19 and the lower conveying roller 18 convey the bundle of sheets to the side of the stapler unit 30 with nipping the bundle of sheets until a binding position of the bundle of sheets reaches a head position of the head assembly 31 whose position is at the initial position. Incidentally, in such a case that the unillustrated stepping motor rotates reversely, the reverse rotation is carried out by interposing an unillustrated one-way clutch between the pulley 10 by which the endless conveying belt 12 is entrained and the pulley shaft 10a, thereby the driving force from the unillustrated stepping motor is not transmitted to the endless conveying belt 12, and both the endless conveying belt 12 and the trusting pawl 13 are retained in a stopped state. Then, binding processing to an upper left portion of the bundle of sheets is carried out by the head assembly 31 and the anvil assembly 32. Incidentally, when the binding processing is carried out to a plural position of the end portion of the bundle of sheets, the processing is carried out after the stapler unit 30 is moved.

After the binding processing is completed, the CPU 3 drives the unillustrated stepping motor so as to actuate the lower conveying roller 18, the upper conveying roller 19, and the endless conveying belt 12 in order to convey the bundle of sheets to the ascending/descending tray 90. According to this driving, the conveying of the bundle of sheets is handed from the conveying by the lower conveying roller 19 and the upper conveying roller 19 over to the conveying by the trusting pawl 13. Since the operation of the ascending/descending tray 90 thereafter is the same as that of the above stated non-binding processing mode, an explanation thereof is omitted.

<(3) Center Binding & Folding Processing Mode>

When receiving the setting information of a center binding and folding processing mode from the CPU 1A, the CPU 3 executes the processing so that the sheet(s) discharged from the copying machine main body 1A is/are stacked on the processing tray 8 in the same manner as the end binding processing mode. After the bundle of sheets is arranged and stacked on the processing tray 8, the CPU 3 drives the upper conveying roller 19 to descend to the side of the lower conveying roller 18 to nip the bundle of sheets and turns off the unillustrated solenoid to position the stopper 21 at the evacuated position. Next, the CPU 3 drives the unillustrated stepping motor reverse to the non-binding processing mode so as to convey the bundle of sheets to the side of the stapler unit 30 in a state that the upper conveying roller 19 and the lower conveying roller 18 are nipping the bundle of sheets.

When the end detecting sensor 54 detects the leading end in the conveying direction of the bundle of sheets after staring the conveying of the bundle of sheets, the CPU 3 drives the unillustrated stepping motor so as to convey the bundle of sheets to a position where a center portion thereof in the sheet conveying direction coincides with a binding position, based on sheet length data of the setting information received from the CPU 1A. Then, the CPU 3 stops the driving of the unillustrated stepping motor and carries out the folding processing to the center portion of the bundle of sheets in the sheet conveying direction.

Subsequently, the CPU 3 drives the upper conveying roller 19 to position at the alienating position to release the nipping of the bundle of sheets in order to conduct the folding processing. Then, the CPU 3 drives the conveying motor 162 to rotate the upper bundle-conveying roller 51 and the lower bundle-conveying roller 52 so as to convey the bundle of sheets downstream further. In this conveying, the CPU 3 slows down the conveying speed of the bundle of sheets and stops the conveying so that the center portion of the bundle of sheets in the sheet conveying direction, namely, the binding position, coincides with the folding position on the basis of a detecting signal from the end detecting sensor 54 and the sheet length data stored in the RAM.

Next, the CPU 3 drives the folding rollers 57a, 57b to rotate in a nipping direction of the bundle of sheets and drives the pushing plate 55 to descend. When the pushing plate 55 descends, the bundle of sheets is caught between the folding rollers 57a, 57b. Then, the pushing plate 55 moves away from the bundle of sheets and the folding rollers 57a, 57b fold (nip and convey) the bundle of sheets further. The bundle of sheets which is nipped and conveyed by the folding rollers 57a, 57b is discharged to the folded bundle discharging stacker 80 and is stacked there.

On the other hand, an unillustrated pushing plate home position sensor detects a predetermined number of reciprocating motions of the pushing plate 55 according to a length in the conveying direction of the bundle of sheets, the CPU 3 stops the operation of each member of the folding unit 50.

<(4) Folding Processing Mode>

When receiving the setting information of a folding processing mode from the CPU 1A, the CPU 3 executes the same processing as the above center binding and folding processing mode. The folding processing mode differs from the center binding and folding processing mode in that the stapler unit 30 does not conduct the binding processing and the folding unit 50 conducts the folding processing. For this reason, after the arranging unit 20 arranges the end portion of the sheet(s), the CPU 3 drives the unillustrated stepping motor to rotate reverse to the non-binding processing mode so as to convey the bundle of sheets to the side of the stapler unit 30 in the state that the upper conveying roller 19 and the lower conveying roller 18 are nipping the bundle of sheets, and then, drives the upper conveying roller 19 to position at the alienating position to release the nipping of the bundle of sheets in order to conduct the folding processing. Subsequently, the CPU 3 drives the conveying motor 162 to rotate the upper bundle-conveying roller 51 and the lower bundle-conveying roller 52 so as to convey the bundle of sheets to the side of the folding unit 50, then, as stated above, drives the folding unit 50 to conduct the folding processing, so that the bundle of sheets to which the folding processing is conducted and the binding processing is not conducted is discharged to the folded bundle discharging stacker 80.

(Effects and the Like)

Next, regarding effects and the like of the copying machine 1 of this embodiment, mainly effects and the like of the sheet perforation apparatus 2 will be explained below.

In the sheet perforation apparatus 2 of the present embodiment, according to the combination of the perforation processing of two or three holes, the sliders 210, 211 (guide grooves 210b, 211b) have the function for advancing the punches 250B, 250E (the operation pins 251B, 251D) from the evacuation position to the perforation position in the case of two holes and for advancing the punches 250A, 250C and 250E (the operation pins 251A, 251C and 251E) from the evacuation position to the perforation position in the case of three holes, and have the function for supporting all of the five punches 250A-250E (the operation pins 251A-251E) between the perforation position and the evacuation position. Accordingly, unlike the prior art, it is not necessary to equip the eccentric cams for locating the punches at the perforation position or the evacuation position and the springs for retaining the punches at the evacuation position. Therefore, the number of the constituting parts of the sheet perforation apparatus 2 can be reduced and the sheet perforation apparatus 2 can be constituted compactly.

Further, in the sheet perforation apparatus 2 of the present embodiment, since the inclined groove portions of the guide grooves 210b, 211b for advancing a part of the punches 250 to the perforation position at every combination of two holes or three holes are formed at the slider 210, 211, the members for moving the punches 250 between the perforation position and the evacuation position are common. Accordingly, it is not necessary that each of the punches 250 equips such a member. Therefore, the number of the constituting parts of the sheet perforation apparatus 2 can be reduced more and the sheet perforation apparatus 2 can be constituted more compactly.

Furthermore, in the sheet perforation apparatus 2 of the present embodiment, the slide holder 201 slides in the direction of the arrow A or B in FIG. 2 according to the normal/reverse rotation of the motor 280, and the slide holder 201 supports the sliders 210, 211 so as the sliders 210, 211 to move freely in the direction orthogonal to the advancing direction of the punches 250. Accordingly, the sheet perforation apparatus 2 can take a sufficient moving stroke for the punches 250 even if a space in the advancing direction for the punches 250 is limited, and the sheet perforation apparatus 2 can be compactly constituted in a size thereof in the advancing direction of the punches 250.

Incidentally, the sheet perforation apparatus 2 was exemplified as a peripheral apparatus of the copying machine main body 1A in the embodiment, however, the present invention is not limited to the same. The sheet perforation apparatus of the present invention is applicable to various types such as a stand-alone type, a unity type in which the apparatus is housed inside the copying machine main body, a type in which the apparatus is housed inside the sheet post-processing apparatus, or the like.

For example, in the stand-alone type, the carrying-in space corresponds to the carrying-in section of the present invention, and the carrying-in section does not necessarily include the conveying guide 245 which functions as a sheet conveying path. Further, in the stand-alone type, the sheet perforation apparatus does not necessarily equip the motor 280 or gears 281 to 286 so as to allow manual perforation processing. In such a manual stand-alone type, it is preferable that the apparatus has a member which indicates a reference of the perforation position to the sheet unlike the embodiment in which the position control for the sheet conveying position (a position for conducting the perforation processing) is not carried out manually.

Further, in the type in which the apparatus is housed inside the sheet post-processing apparatus, for example, the sheet detecting sensor 4 and the conveying roller pair 5 may be disposed at a downstream side more and the sheet perforation apparatus may be disposed at the conveying guide 40. Furthermore, since the sheet post-processing apparatus 3 of this embodiment has the arranging unit 20, the sheet perforation apparatus may be disposed at a downstream side of the arranging unit 20 or at a downstream side of the stapler unit 30. When such a constitution is adopted, speedier sheet post-processing may be realized since the perforation processing to the bundle of sheets can be conducted at once. In this case, the advancing stroke of the punches 250 should be long enough to penetrate a thickness of the bundle of sheets, however, since the slide holder 201 supports the sliders 210, 211 so as to move freely in the direction orthogonal to the advancing direction of the punches 250 in the sheet perforation apparatus 2 of this embodiment as stated above, not only the size of the sheet perforation apparatus but that of the sheet post-processing apparatus in the advancing direction of the punches 250 can be made compactly.

Furthermore, in the sheet perforation apparatus 2 in this embodiment, an example that the punches 250 have the operation pins 251 and the operation pins 251 engage the guide grooves 210b, 211b of the sliders 210, 211. However, the operation pins may be formed at the sides of the sliders 210, 211 and the portions to be engaged which engage the operation pins may be formed at the punches 250. In such a case, the shape of the punches is not confined to the cylindrical shape as shown and it may take various shapes such as only the portion of the perforation blades may have a shape for forming a desired punching hole and the shape of the punches may match the shape of the operation pins.

Moreover, in the sheet perforation apparatus 2 of this embodiment, an example of conducting the perforation processing of two or three holes was shown. However, the present invention is not limited to the same, and it goes without saying that the present invention is applicable to various shapes of holes and the number of holes so as to meet request of file binders.

What is claimed is:

1. A sheet perforation apparatus, comprising:
a carrying-in section for carrying in a sheet;
a plurality of perforation blades for conducting perforation processing to a sheet carried in to the carrying-in section; and
a slider, which sets the perforation blades to a selective plural combination, and which has an advance portion for advancing a part of the perforation blades to a perforation position where the perforation processing is conducted to the sheet according to the combination and an evacuation portion for retaining perforation blades other than the part of the perforation blades at an evacuation position that is evacuated from the perforation position, and which supports all of the perforation blades so as the perforation blades to move freely between the evacuation position and the perforation position.

2. A sheet perforation apparatus according to claim 1, wherein the advance portion is constituted by a common member which allows the part of the perforation blades to advance to the perforation position at every combination.

3. A sheet perforation apparatus according to claim 1, wherein perforation blades next to each other belong to a different combination.

4. A sheet perforation apparatus according to claim 1, wherein the slider locates the perforation blades at the perforation position and at the evacuation position by moving to a predetermined position according to the combination.

5. A sheet perforation apparatus according to claim 4, wherein each of the perforation blades has a protruded portion, and a predetermined-shaped guide groove which engages the protruded portion and which supports the perforation blades between the perforation position and the evacuation position is formed at the slider.

6. A sheet perforation apparatus according to claim 4, wherein each of the perforation blades has a portion to be engaged, the slider has an engaging portion which engages the portion to be engaged and which supports the each of the perforation blades between the perforation position and the evacuation position.

7. A sheet perforation apparatus according to claim 4, further comprising a slide holder which supports the slider so as to slide freely and which moves the slider to the predetermined position.

8. A sheet perforation apparatus according to claim 7, wherein the slide holder supports the slider in a direction orthogonal to an advancing direction of the perforation blades.

9. A sheet perforation apparatus according to claim 4, further comprising an actuator for moving the slider to the predetermined position.

10. A sheet perforation apparatus according to claim 8, further comprising an actuator for moving the slider to the predetermined position.

11. An image forming apparatus, comprising:
an image forming part for forming an image on a sheet;
a conveying part for conveying the sheet on which the image is formed by the image forming part;
a plurality of perforation blades for conducting perforation processing to the sheet conveyed by the conveying part; and
a slider, which sets the perforation blades to a selective plural combination, and which has an advance portion for advancing a part of the perforation blades to a perforation position where the perforation processing is conducted to the sheet according to the combination and an evacuation portion for retaining perforation blades other than the part of the perforation blades at an evacuation position that is evacuated from the perforation position, and which supports all of the perforation blades so as the perforation blades to move freely between the evacuation position and the perforation position.

12. An image forming apparatus according to claim 11, wherein the advance portion is constituted by a common member which allows the part of the perforation blades to advance to the perforation position at every combination.

13. An image forming apparatus according to claim 11, wherein perforation blades next to each other belong to a different combination.

14. An image forming apparatus according to claim 11, wherein the slider locates the perforation blades at the perforation position and at the evacuation position by moving to a predetermined position according to the combination.

15. An image forming apparatus according to claim 14, wherein each of the perforation blades has a protruded portion, and a predetermined-shaped guide groove which engages the protruded portion and which supports the perforation blades between the perforation position and the evacuation position is formed at the slider.

16. An image forming apparatus according to claim 14, wherein each of the perforation blades has a portion to be engaged, the slider has an engaging portion which engages the portion to be engaged and which supports the each of the perforation blades between the perforation position and the evacuation position.

17. An image forming apparatus according to claim 14, further comprising a slide holder which supports the slider so as to slide freely and which moves the slider to the predetermined position.

18. An image forming apparatus according to claim 17, wherein the slide holder supports the slider in a direction orthogonal to an advancing direction of the perforation blades.

19. An image forming apparatus according to claim 14, further comprising an actuator for moving the slider to the predetermined position.

20. An image forming apparatus according to claim 18, further comprising an actuator for moving the slider to the predetermined position.
